(19) United States
(12) Patent Application Publication
(10) Pub. No.: US 2026/0359589 A1
(43) Pub. Date: Nov. 12, 2026

(54) INFORMATION PROCESSING APPARATUS, METHOD FOR CONTROLLING INFORMATION PROCESSING APPARATUS, AND STORAGE MEDIUM

(71) Applicant: CANON KABUSHIKI KAISHA, Tokyo (JP)

(72) Inventor: KOJI ITO, Tokyo (JP)

(21) Appl. No.: 19/665,858

(22) Filed: May 1, 2026

(30) Foreign Application Priority Data
May 8, 2025 (JP) 2025-078028

(51) Int. Cl. G06K 15/02; G06T 7/73; G06T 11/60

(52) U.S. Cl. CPC G06K 15/1859; G06K 15/1822; G06K 15/186; G06T 7/73; G06T 11/60

(57) ABSTRACT

An information processing apparatus includes at least one memory and at least one processor. The at least one memory and at least one processor are configured to acquire position information, issue a request to acquire, for the position information, a first-level place name and a second-level place name at a lower level than the first level, and perform control such that in a case where the second-level place name is acquired in response to the request, the second-level place name is output without outputting the first-level place name and without requiring user operation for selecting a place name after the request, and such that in a case where the second-level place name is not acquired while the first-level place name is acquired in response to the request, the first-level place name is output.

### BACKGROUND

### Field of the Technology

The present disclosure relates to an information processing apparatus, a method for controlling the information processing apparatus, and a storage medium, and in particular to a technology for outputting a place name using position information.

### Description of the Related Art

A technology that prints an image with date information and/or a capture location superimposed on the image is known.

Japanese Patent Laid-Open No. 2010-240899 describes referencing a place information database based on position information derived from a Global Positioning System (GPS) signal added to picture data, acquiring place information, and printing a picture image with the place information superimposed on the picture image. The place information database associates position information including a longitude and a latitude with a name of a place indicated by the position information and a name of a building located at the place.

A place information database (place name information database) manages a plurality of place names with different levels (hierarchical levels) of detail, such as a detailed municipal-level place name and an approximate prefectural-level place name, as place names corresponding to position information. If a user is required to perform an operation to designate a place name to be used from the plurality of place names with different levels (hierarchical levels) of detail each time, the number of required operations increases, which is inconvenient for the user. Further, in a case where the place names managed in the place name information database are insufficient, a detailed place name corresponding to the position information may not be obtainable. In a case where a detailed place name cannot be obtained but an approximate place name can be obtained, not outputting a place name simply because the detailed place name cannot be obtained may degrade usability. Japanese Patent Laid-Open No. 2010-240899 does not consider a situation in which a plurality of place names with different levels (hierarchical levels) of detail is managed.

### SUMMARY

Embodiments of the present disclosure are directed to providing a mechanism that enables, with good operability, a more suitable place name to be used from among a plurality of place names with different hierarchical levels.

An information processing apparatus includes at least one memory and at least one processor that are configured to acquire position information, issue a request to acquire, for the position information, a first-level place name and a second-level place name at a lower level than the first level, and perform control such that in a case where the second-level place name is acquired in response to the request, the second-level place name is output without outputting the first-level place name and without requiring user operation for selecting a place name after the request, and such that in a case where the second-level place name is not acquired while the first-level place name is acquired in response to the request, the first-level place name is output.

Features of various embodiments will become apparent from the following description of embodiments with reference to the attached drawings. The following description of embodiments is described by way of example.

### BRIEF DESCRIPTION OF THE DRAWINGS

FIG. 1 is a block diagram illustrating a configuration of a data processing system according to an embodiment.

FIG. 2 is a block diagram illustrating a hardware configuration of an image processing apparatus.

FIG. 3 illustrates an example of a display of a print setting screen.

FIG. 4 illustrates an example of a display of an advanced setting screen.

FIGS. 5A and 5B illustrate examples of a display of a capture location setting screen.

FIGS. 6A and 6B are diagrams illustrating examples of position information and place name information.

FIG. 7 is a flowchart illustrating a print setting process.

FIG. 8 is a diagram illustrating a data structure of place name management information.

FIG. 9 is a flowchart illustrating a process for updating place name management information.

FIG. 10 illustrates an example of a display of notification information indicating that acquisition of place name information has failed.

FIG. 11 is a flowchart illustrating a process for updating a character string indicating a place name.

FIG. 12 is a flowchart illustrating an advanced setting process.

FIG. 13 is a flowchart illustrating a capture location setting process.

FIG. 14 is a flowchart illustrating a process for updating a capture location setting screen.

FIGS. 15A-15C are diagrams illustrating examples of layouts of a character string indicating a place name and a character string indicating a date.

FIG. 16 illustrates an example of a display of a checkbox for batch application of a place name.

FIG. 17 illustrates an example of an image on which a character string indicating a place name indicated by a plurality of items of place name information is superimposed.

### DESCRIPTION OF THE EMBODIMENTS

A place information database (place name information database) manages a plurality of place names with different levels (hierarchical levels) of detail, such as a detailed municipal-level place name and an approximate prefectural-level place name, as place names corresponding to position information. If a user is required to perform an operation to designate a place name to be used from the plurality of place names with different levels (hierarchical levels) of detail each time, the number of required operations increases, which is inconvenient for the user. Further, in a case where the place names managed in the place name information database are insufficient, a detailed place name corresponding to the position information may not be obtainable. In a case where a detailed place name cannot be obtained but an approximate place name can be obtained, not outputting a place name simply because the detailed place name cannot be obtained may degrade usability. Japanese Patent Laid-Open No. 2010-240899 does not consider a situation in which a plurality of place names with different levels (hierarchical levels) of detail is managed.

Further, even in a case where acquisition of name information about a place indicated by position information is attempted, such place name information may not be obtainable due to factors such as a network environment, the presence or absence of the position information in the image, or the presence or absence of the place name information in the database. In a case where no place name is output as a result of a failure to acquire the place name information, a user may erroneously recognize that a malfunction (such as a freeze or a failure) has occurred in an apparatus. On the other hand, in a case where information different from the place name is superimposed on the image as a result of a failure to acquire the place name when the image is intended to be output with the place name superimposed on the image, the quality of the image may be degraded. Japanese Patent Laid-Open No. 2010-240899 does not consider a case where place name information about an image cannot be acquired.

Further, in a case where perceptible additional information is superimposed on an image, it is appropriate to place the additional information on the image so that the additional information does not overlap an important subject. However, in a case where a plurality of types of additional information, such as a place name and a date, is superimposed on an image, an issue remains regarding the appropriate placement. Japanese Patent Laid-Open No. 2010-240899 does not consider the placement in a case where a plurality of types of additional information is superimposed.

An embodiment of the present disclosure will be described with reference to the drawings.

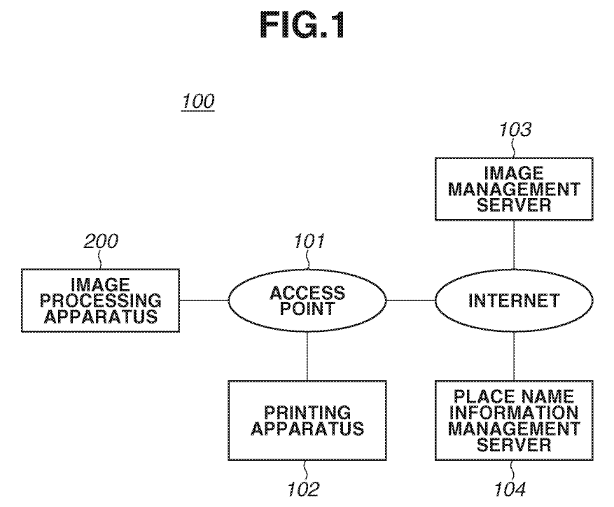

FIG. 1 is a block diagram illustrating a configuration of a data processing system 100 according to the present embodiment.

The data processing system 100 includes an access point 101, an image processing apparatus 200, and a printing apparatus 102. The image processing apparatus 200 and the printing apparatus 102 are connected to each other via a network established by the access point 101. More than one image processing apparatus 200 and more than one printing apparatus 102 may be connected.

The access point 101 is a wireless local area network (wireless LAN) parent station that includes a standard network/router function and provides a wireless LAN using Wi-Fi® in a location such as a home or an office. The access point 101 is an access point (AP) configured for wireless LAN communication in infrastructure-mode. LAN stands for Local Area Network.

The image processing apparatus 200 is a mobile terminal, such as a smartphone, and an operating system for small terminals and a program configured to control calls and data communication run on the image processing apparatus 200. Further, the image processing apparatus 200 may be a personal computer without audio control, position detection control, mobile phone data communication, or the like. Further, the image processing apparatus 200 is configured to store a program, such as printing application software (hereinafter, “printing application”), which will be described below. Print data created using the printing application may be transmitted to the printing apparatus 102 via the network established by the access point 101. The image processing apparatus 200 is configured to connect to the Internet via the access point 101, download the printing application via the Internet, and install the printing application. Further, the image processing apparatus 200 is configured to install the printing application from a recording medium attached to the image processing apparatus 200. Further, the image processing apparatus 200 is configured to connect to an image management server 103 and a place name information management server 104 via the network established by the access point 101 and the Internet.

The printing apparatus 102 (image processing apparatus, image forming apparatus) is a printer and a digital multi-function peripheral including a plurality of job execution functions, such as printer, copy, scanner, and fax transmission functions. The user can issue an instruction to execute a job, such as a print, scan, or fax job, to the printing apparatus 102 by operating the image processing apparatus 200.

The image management server 103 is a server configured to allow the user to store image data captured by an image capturing apparatus, such as a camera, and is configured to connect to the image processing apparatus 200 via the network established by the access point 101 and the Internet.

The place name information management server 104 is a system using a positioning sensor, such as the Global Positioning System (GPS). The place name information management server 104 is a server system configured to manage place name information corresponding to position information and is configured to connect to the image processing apparatus 200 via the network established by the access point 101 and the Internet. The place name information management server 104 functions as a database of the place name information (place information) indicating a name of a place corresponding to the position information.

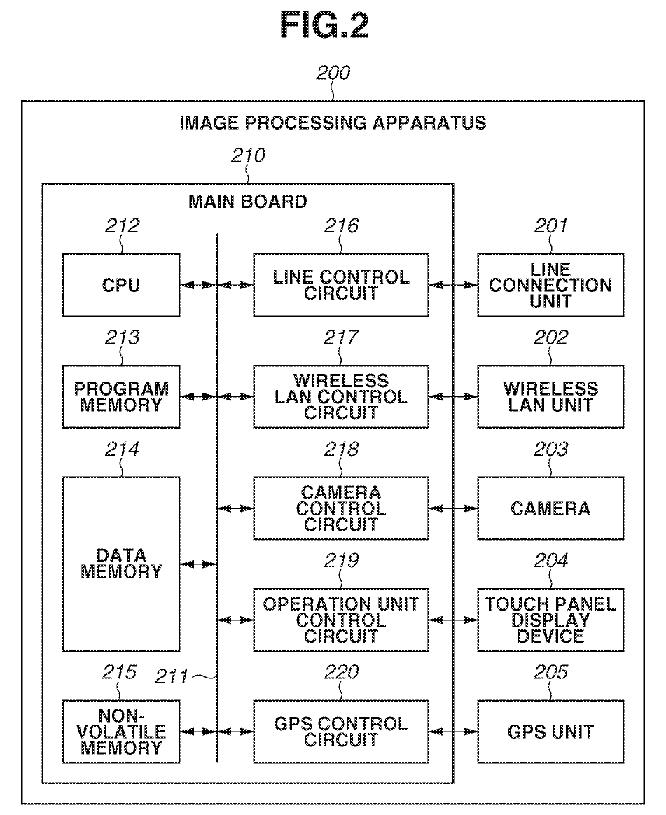

FIG. 2 is a block diagram illustrating a hardware configuration of the image processing apparatus 200. The image processing apparatus 200 includes a line connection unit 201, a wireless LAN unit 202, a camera 203, a touch panel display device 204, and a GPS unit 205. The image processing apparatus 200 may include a unit configured to perform communication using another method, such as Bluetooth® Low Energy (BLE).

Further, various memories and circuits are connected via an internal bus 211 in the image processing apparatus 200. Specifically, a central processing unit (CPU) 212, a program memory 213, a data memory 214, a non-volatile memory 215, a line control circuit 216, a wireless LAN control circuit 217, a camera control circuit 218, an operation unit control circuit 219, and a GPS control circuit 220 are connected. The CPU 212 includes at least one processor (one or more processors) and controls the entire system of the image processing apparatus 200. The program memory 213 is implemented as a read-only memory (ROM) and is configured to store an embedded operating system (OS) of the image processing apparatus 200 and a program, such as the printing application according to the present embodiment. The data memory 214 is implemented as a random access memory (RAM) and is a memory used by the CPU 212 to execute various programs and also a working memory area used by the application during program execution. The non-volatile memory 215 includes a memory, such as a flash memory, and stores data configured to be retained even after the image processing apparatus 200 is re-activated (such as image data configured to be retained and application program management information managed by the printing application). In the present embodiment, each application program stored in the program memory 213 is executed under the management of the OS, which controls software execution. Specifically, this is realized by the CPU 212 by loading an application program stored in the program memory 213 into the data memory 214.

The line control circuit 216 is connected to the line connection unit 201 to connect to a mobile phone network and is configured to perform calls and data transmission/reception. The wireless LAN control circuit 217 is connected to the wireless LAN unit 202 and performs wireless LAN communication with another apparatus. The wireless LAN unit 202 is configured to perform data (packet) communication using a communication method compliant with the Institute of Electrical and Electronics Engineers (IEEE) 802.11 series (such as IEEE 802.11a, 802.11b, and 802.11g). The camera control circuit 218 controls image capturing via the camera 203. The CPU 212 is configured to store an image captured by the camera control circuit 218 via the camera 203 in the data memory 214 or the non-volatile memory 215. The operation unit control circuit 219 performs output control on image data displayed by the touch panel display device 204 and performs input control on a user operation performed via the touch panel display device 204. The GPS control circuit 220 determines a current position based on information from the GPS via the GPS unit 205. The CPU 212 is configured to record a capture location for each image file captured by the camera control circuit 218 via the camera 203 by embedding information about the determined position in the image file. The CPU 212 is configured to store an image acquired from an external source, besides an image captured by the camera control circuit 218 via the camera 203, in the data memory 214 or the non-volatile memory 215 or transmit the image to an external source. Specific images are an image acquired via the mobile phone network connected via the line control circuit 216 and the line connection unit 201 and an image acquired via the Internet connected via the wireless LAN control circuit 217 and the wireless LAN unit 202.

A process for superimposing a place name on an image to be printed using the printing application will be described.

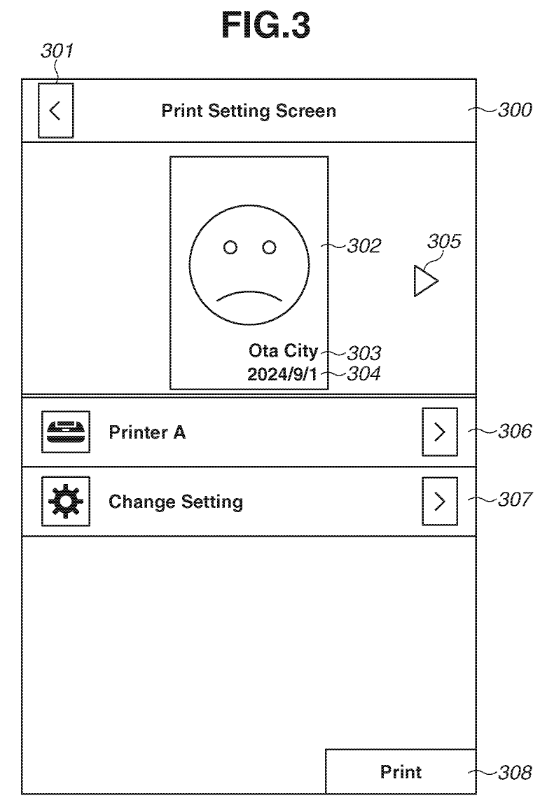

FIG. 3 illustrates an example of a print setting screen 300 displayed on the touch panel display device 204 and provided by the printing application. In a case where the image processing apparatus 200 activates the printing application (the printing application is opened) in response to an instruction and an image to be printed is selected via a top screen and an image selection screen, the print setting screen 300 is displayed. The top screen is configured to receive a user selection specifying what printing is to be performed, and displays selection items, such as picture printing, picture layout, calendar, card, disc label, and collage. In a case where picture printing is selected from the selection items, a screen is displayed to prompt selection between a picture stored in the terminal (an image file stored in the recording medium managed by the image processing apparatus 200) and a web service (an image file stored on a server on the Internet). In a case where the picture stored in the terminal is selected, a thumbnail list of image files stored in the recording medium managed by the image processing apparatus 200 is displayed as an image option list (picture selection screen). In a case where the web service is selected, a thumbnail list of image files stored on the server on the Internet and corresponding to a user account is displayed as an image option list (picture selection screen). In a case where a user operation to select one or more images is received on the picture selection screen, the print setting screen 300 in FIG. 3 is displayed to receive a print setting related to the selected image.

A region 301 is a return button. Touching the region 301 causes a transition to a previously displayed screen before the print setting screen 300. A region 302 is configured to display a print preview image of an image selected on the picture selection screen by the user. In a case where a capture location setting, which will be described below, is on, a place name 303 is superimposed and displayed on a preview image displayed in the region 302, and in a case where a date setting, which will be described below, is on, a date 304 specifying a date and time (capture date) of image capture is superimposed and displayed on the preview image displayed in the region 302. A region 305 is a display image switching button configured to switch the image displayed in the region 302 in a case where a plurality of images is to be printed in batch. A region 306 is a printer management item and displays identification information about a printer that is currently registered and to which a print instruction may be issued. Further, touching the region 306 executes a printer management process, which is a process for changing a printer to which a print instruction may be issued.

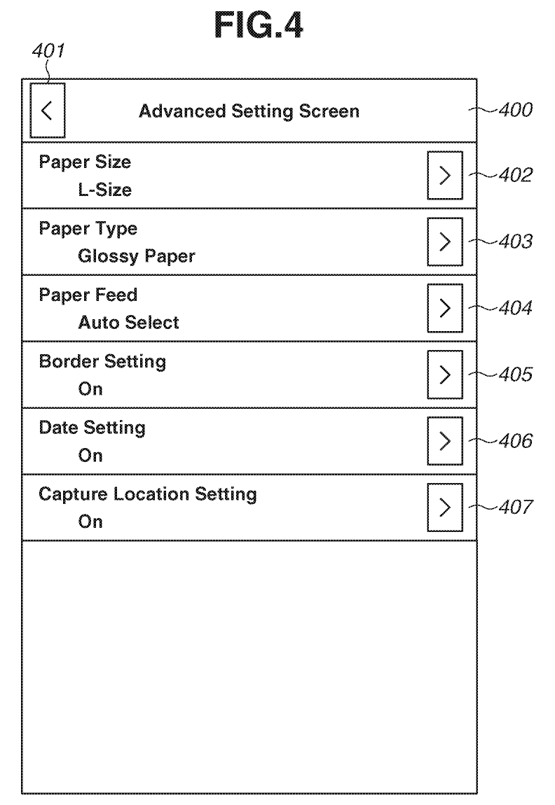

A region 307 is a setting change item and displays information indicating a transition to an advanced setting screen. Touching the region 307 causes a transition to the advanced setting screen. The advanced setting screen will be described below with reference to FIG. 4. A region 308 is a print button. Touching the region 308 issues a print instruction to the printer displayed in the region 306. In other words, a print job is transmitted to the printer.

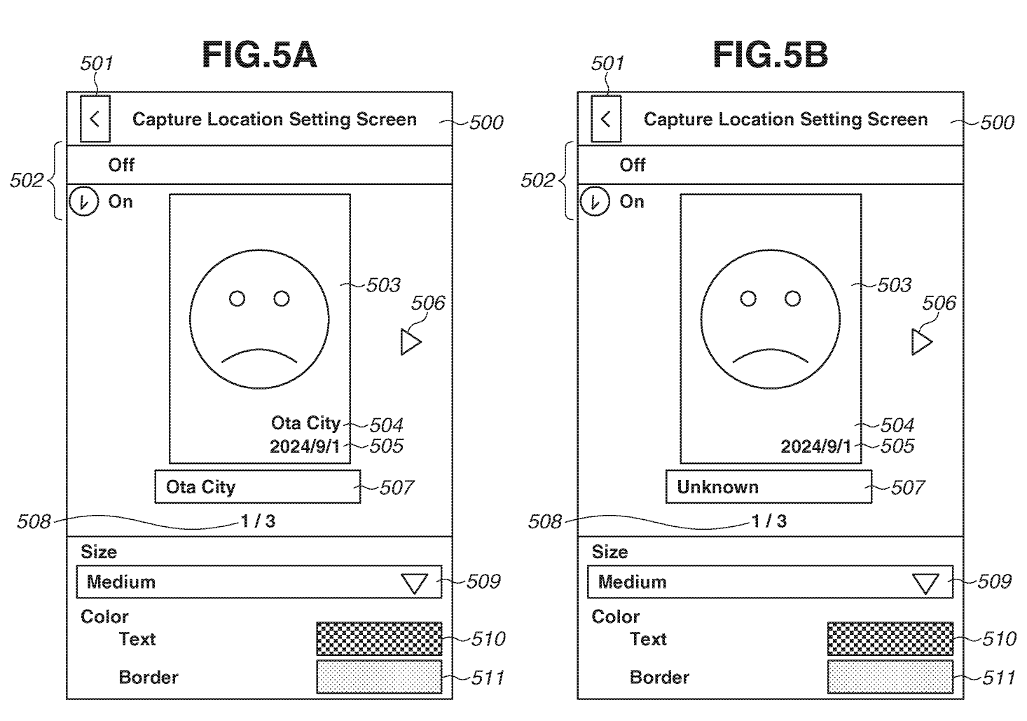

FIG. 4 illustrates an example of an advanced setting screen 400 displayed on the touch panel display device 204 and provided by the printing application. A region 401 is a return button. Touching the region 401 causes a transition to the print setting screen 300 displayed before the advanced setting screen 400. Regions 402 to 407 are options for various setting items. Touching and selecting one of the regions 402 to 405 executes a process corresponding to the touched option, such as a paper size setting process, a paper type setting process, a paper feed method setting process, or a border setting process. The region 406 is a date setting item. Touching and selecting the region 406 executes a date setting process. The region 407 is a capture location setting item. Touching and selecting the region 407 causes a transition to a capture location setting screen. Details of the capture location setting screen will be described below with reference to FIGS. 5A and 5B.

FIGS. 5A and 5B illustrate examples of a capture location setting screen 500 displayed on the touch panel display device 204 and provided by the printing application. A region 501 is a return button. Touching the region 501 causes a transition to the advanced setting screen 400 displayed before the capture location setting screen 500. A region 502 displays “On” and “Off” to indicate whether the capture location setting is on or off. In a case where “On” is selected, a mark indicating activation is provided next to the display indicating “On”, and in a case where “Off” is selected, the mark indicating activation is provided next to the display indicating “Off”. The illustrated example is an example of a display in a case where the capture location setting is on. A region 503 is a preview display portion, and an image based on Scalable Vector Graphics (SVG) data to which an image selected on the picture selection screen, with the results of date and capture location settings superimposed, is applied is displayed as a preview image. In a case where the capture location setting is on, a place name 504 is superimposed and displayed on an area configured to be superimposed on the preview image displayed in the region 503, and in a case where the date setting, which will be described below, is on, a date 505 is superimposed and displayed on the preview image displayed in the region 503. A region 506 is a display image switching button configured to switch the preview image displayed in the region 503 in a case where a plurality of images is selected.

A region 507 is a textbox that is displayed within an area not configured to be superimposed on the image and is configured to display a character string indicating a place name to be superimposed on the image. In a case where acquisition of place name information from the place name information management server 104 succeeds, the region 507 displays a character string indicating the acquired place name (which is “Ota City” in the illustrated example), as illustrated in FIG. 5A. Further, in a case where acquisition of place name information fails, “(Unknown)” is displayed as a character string indicating the failure to acquire place name information, as illustrated in FIG. 5B. Further, in a case where a character string input operation is performed by the user, the region 507 displays the character string input by the user, regardless of whether place name information is acquired. Further, the character string displayed in the region 507 is generally superimposed as the place name 504 on the preview image in the region 503 as illustrated in FIG. 5A. On the other hand, in a case where place name information cannot be acquired, while the region 507 displays the character string “(Unknown)” as illustrated in FIG. 5B, any display item resulting from the request for place name information, such as the character string “(Unknown)”, is not superimposed on the preview image in the region 503. In other words, no place name or error information is displayed at the position of the place name 504. In a case where the region 507 displays “(Unknown)”, the CPU 212 may display details of the cause of the failure to acquire place name information and an action to be taken by the user to acquire place name information as notification information on the capture location setting screen 500. For example, notification information such as “The image data includes no position information about the image” or “No information corresponding to position information about the image is registered on the place name information management server” may be displayed.

A region 508 displays a character string that displays the total number of selected images and a selected image index to display the ordinal position of the preview image displayed in the region 503 among all selected images. A region 509 displays a size of the place name 504 superimposed on the preview image in the region 503. Touching the region 509 executes a font size setting process to change the size of the superimposed character string indicating the place name. A region 510 displays a color of the place name 504 superimposed on the preview image in the region 503. Touching the region 510 executes a character string color setting process to change the color of the superimposed character string indicating the place name. A region 511 displays a border color of the place name 504 superimposed on the preview image in the region 503. Touching the region 511 executes a border setting process to change the border color of the superimposed character string.

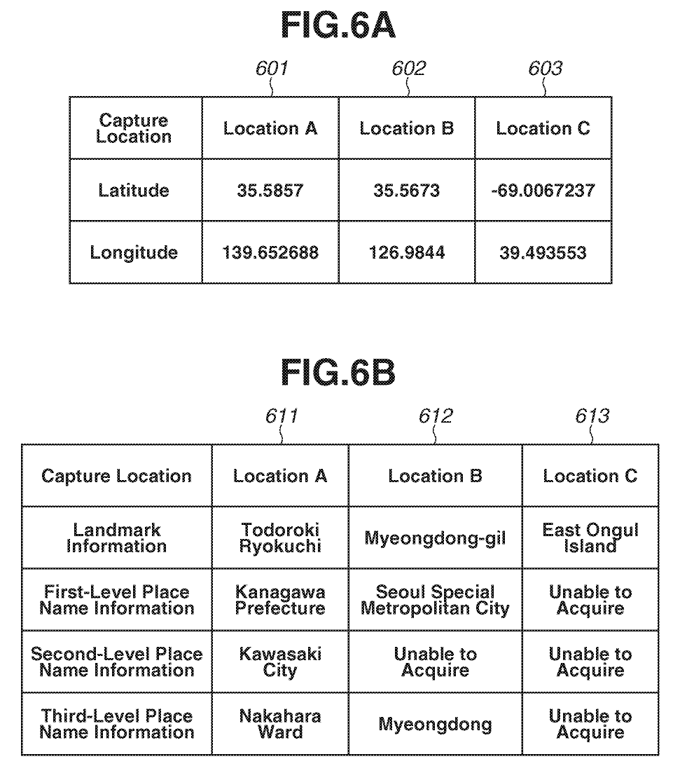

In a case where the image processing apparatus 200 is connected to the Internet, the CPU 212 acquires place name information corresponding to position information recorded in attribute information about the image from the place name information management server 104 using a place name information acquisition application programming interface (place name information acquisition API). API stands for Application Programming Interface. FIG. 6A illustrates an example of position information included in an image file. Further, FIG. 6B illustrates an example of place name information corresponding to position information and acquired using the place name information acquisition API (an example of place name information managed by the place name information management server 104).

FIG. 6A is a table illustrating examples of latitudes and longitudes specified by three items of position information. Columns 601 to 603 present position information acquired by the GPS at different positions. The latitude and the longitude presented in the column 601 are position information acquired at a location (location A) in Todoroki Ryokuchi. The latitude and the longitude presented in the column 602 are position information acquired at a location (location B) in Seoul. The latitude and the longitude presented in the column 603 are position information acquired at a location (location C) in Antarctica. In an image file of an image captured at the location A (an image having the location A as the capture location), the position information acquired by the GPS and presented in the column 601 is recorded. In an image file of an image captured at the location B (an image having the location B as the capture location), the position information acquired by the GPS and presented in the column 602 is recorded. In an image file of an image captured at the location C (an image having the location C as the capture location), the position information acquired by the GPS and presented in the column 603 is recorded.

FIG. 6B illustrates examples of place names acquired in response to queries about place names corresponding to the position information about the locations A to C illustrated in FIG. 6A to the place name information management server 104. Columns 611 to 613 present place name information acquired as place name information corresponding to the position information presented in the columns 601 to 603. For a single item of position information, a maximum of four place names is acquired, including landmark information, first-level place name information corresponding to a parent level, second-level place name information, and third-level place name information. The third- level place name information is included in the place name indicated by the second-level place name information, and the second-level place name information is included in the place name indicated by the first-level place name information. In other words, the third- level place name information is place name information at a lower level of the second- level place name information, and the second-level place name information is place name information at a lower level of the first-level place name information. For example, "Nakahara Ward", which is the third-level place name information in the column 611, is geographically located within an area of "Kawasaki City", which is the second-level place name information in the column 611. Similarly, "Kawasaki City", which is the second- level place name information in the column 611, is geographically located within an area of "Kanagawa Prefecture", which is the first-level place name information in the column 611. Conversely, "Kawasaki City" is the name of an area included in "Kanagawa Prefecture", and "Nakahara Ward" is the name of an area included in "Kawasaki City". Other examples of the first-level place name information and the second-level place name information include "New York State" being the first level place name information and "Manhattan" being the second level place name information. The first to third levels in the column 611 further correspond to a hierarchical structure of administrative regions (prefecture > city > ward). In other words, the first-level place name information, the second-level place name information, and the third-level place name information respectively correspond to a prefectural-level place name, a municipal-level place name, and place name information at a level more detailed than the second level. The landmark information is a name that is independent of the hierarchical structure of the place name and indicates a distinctive object being a geographical landmark for the position information, and may be included in any, none, or all of the first-level place name information to the third-level place name information. For example, "Todoroki Ryokuchi", which is the landmark information in the column 611, is an area included in "Nakahara Ward" and is geographically included in "Nakahara Ward".

Further, the landmark information may be “Mount Fuji”, which is the name of a mountain extending across parts of “Yamanashi Prefecture” and “Shizuoka Prefecture” in Japan, and no inclusion relationship (hierarchical relationship) exists between “Shizuoka Prefecture” and “Yamanashi Prefecture”, which may serve as the first-level place name information.

A query about a place name corresponding to position information to the place name information management server 104 may not return one or more of the landmark information, the first-level place name information, the second-level place name information, and the third-level place name information. This occurs due to lack of the information on the place name information management server 104. Each item of information for which “Unable to Acquire” is recorded in a column 612 or 613 indicates that the CPU 212 cannot acquire place name information despite using the place name information acquisition API due to lack of the place name information on the place name information management server 104. For example, in the column 613, the first-level place name information, the second-level place name information, and the third-level place name information are not acquired. Since the location C is Antarctica, no administrative regions exist, and no place name corresponding to the first-level place name information, the second-level place name information, or the third-level place name information is associated. Further, even in a case where position information corresponds to a location where a landmark or an administrative region exists in the real world, it is still not possible to acquire the landmark information, the first-level place name information, the second-level place name information, and/or the third-level place name information not registered in the place name information management server 104.

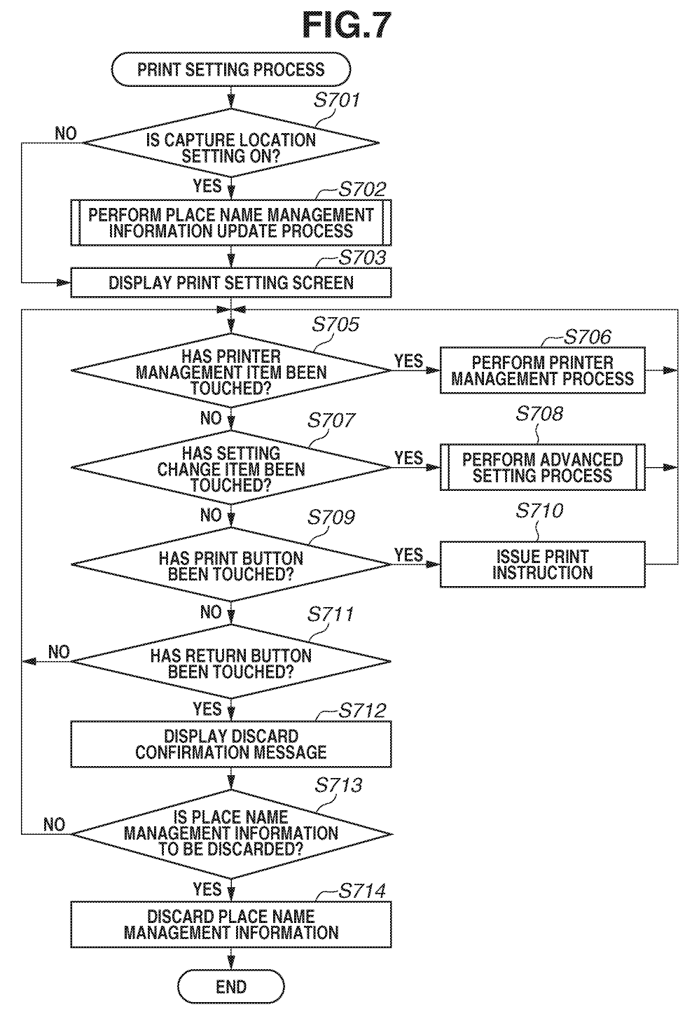

FIG. 7 is a flowchart illustrating a print setting process. The process in FIG. 7 is started in a case where the image processing apparatus 200 activates the printing application (the printing application is opened) in response to an instruction and an image to be printed is selected via the top screen and the picture selection screen. The process is realized by the CPU 212 by loading the printing application program recorded in the program memory 213 into the data memory 214 and executing the program.

In step S701, the CPU 212 determines whether the capture location setting is on. In a case where the capture location setting is on (YES in step S701), the processing proceeds to step S702. In a case where the capture location setting is off (NO in step S701), the processing proceeds to step S703.

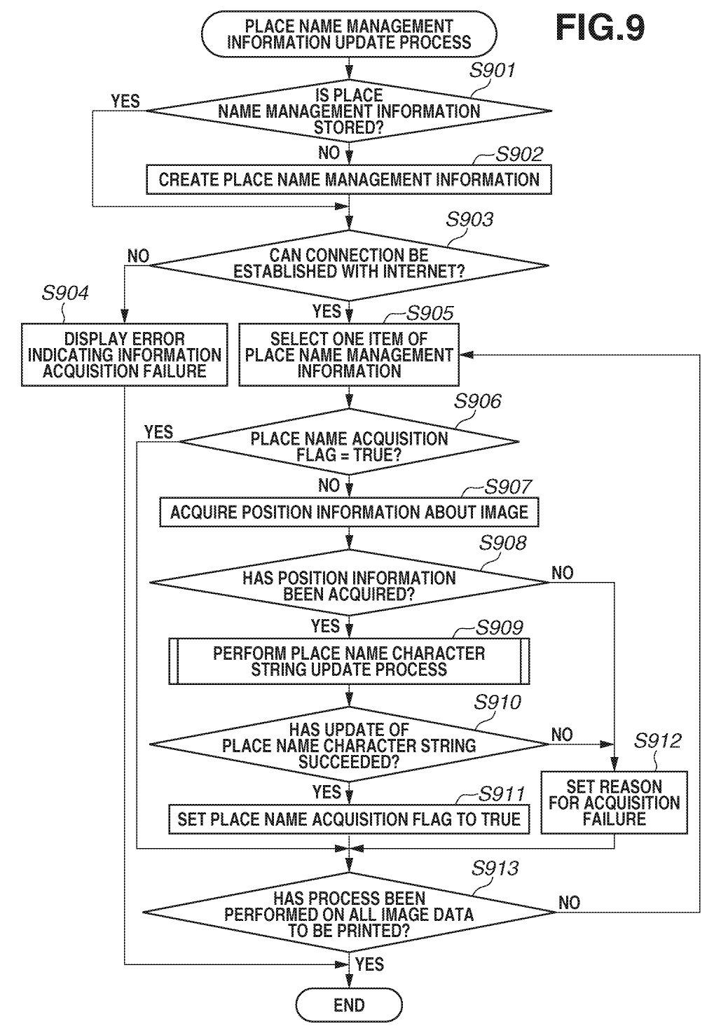

In step S702, the CPU 212 performs a process for updating place name management information. The process for updating place name management information will be described below with reference to FIG. 9. The process for updating place name management information is not performed during a process before step S702 (i.e., a process during which the top screen or the picture selection screen is displayed).

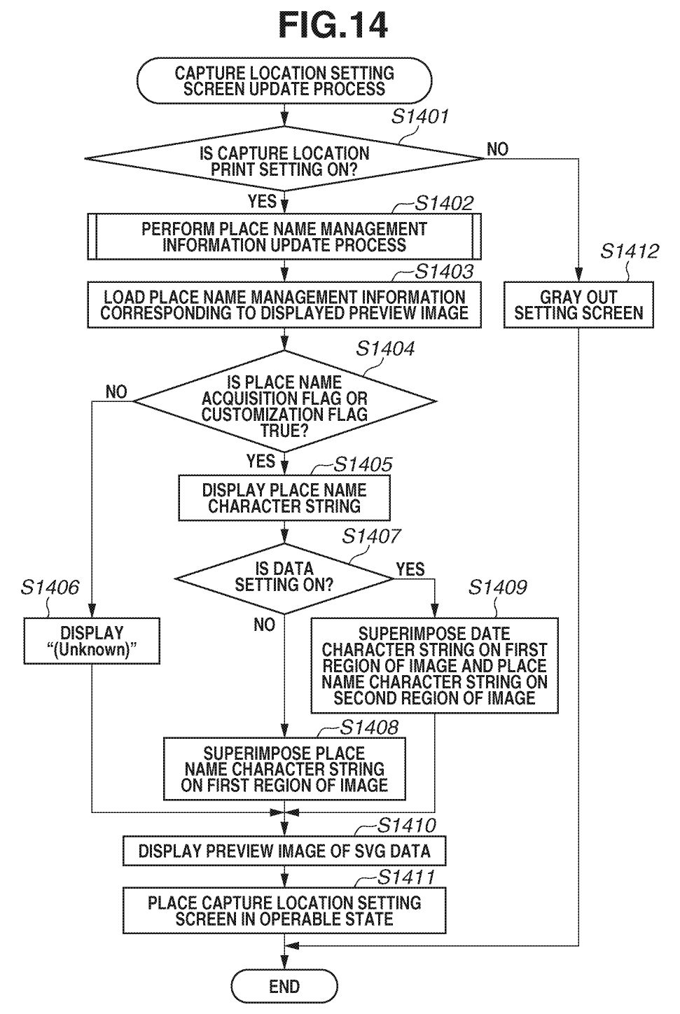

In step S703, the CPU 212 displays the print setting screen 300 illustrated in FIG. 3. At this time, processes similar to steps S1403 to S1410 in FIG. 14, which will be described below, are performed to create SVG data of the image to be printed, and a reduced image of the created SVG data is displayed as a preview image in the region 302. After an image to be printed is selected and the process illustrated in FIG. 7 is started, the print setting screen 300 illustrated in FIG. 3 is displayed in a case where the capture location setting is on in step S701 without user operation (such as an operation for inputting, selecting, or placing a place name).

Further, in a case where place name information is acquired after a request to acquire the place name information is issued during the process performed in step S702, the reduced image of the SVG data with the place name superimposed thereon is displayed in the region 302 without user operation.

In step S705, the CPU 212 determines whether the printer management item (the region 306) has been touched. In a case where the region 306 has been touched (YES in step S705), the processing proceeds to step S706. In a case where the region 306 has not been touched (NO in step S705), the processing proceeds to step S707.

In step S706, the CPU 212 performs the printer management process, which is a process for changing the printer to which a print instruction may be issued.

In step S707, the CPU 212 determines whether the setting change item (the region 307) has been touched. In a case where the region 307 has been touched (YES in step S707), the processing proceeds to step S708. In a case where the region 307 has not been touched (NO in step S707), the processing proceeds to step S709.

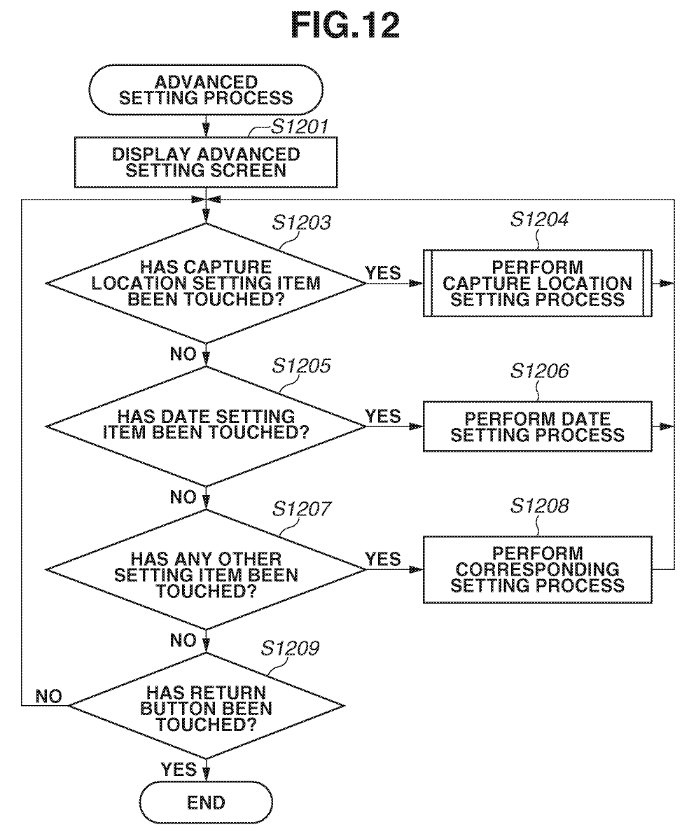

In step S708, the CPU 212 performs an advanced setting process. The advanced setting process will be described below with reference to FIG. 12.

In step S709, the CPU 212 determines whether the print button (the region 308) has been touched. In a case where the region 308 has been touched (YES in step S709), the processing proceeds to step S710. In a case where the region 308 has not been touched (NO in step S709), the processing proceeds to step S711. The CPU 212 stores the settings set in steps S1204 to S1207 in FIG. 12, which will be described below, in the non-volatile memory 215 when the region 308 is touched. Thus, when the printing application is terminated and then re-activated by the user, the SVG data to which the settings stored in the non-volatile memory 215 have been applied is displayed in the region 302 in step S703. In other words, in a case where the capture location setting is on during a previous activation of the printing application, the image to be printed can be printed with the place name superimposed on the image in the absence of a setting operation on the capture location setting screen in FIGS. 5A and 5B by the user. Accordingly, the burden on the user can be reduced.

In step S710, the CPU 212 transmits a print job including the image to be printed and a print request to the printer to which a print instruction may be issued, as a process for issuing a print instruction. At this time, in a case where the capture location setting is on and place name information is available, the image with the place name superimposed on the image is transmitted to the printer as the image to be printed.

In step S711, the CPU 212 determines whether the return button (the region 301) has been touched. In a case where the region 301 has been touched (YES in step S711), the processing proceeds to step S712. In a case where the region 301 has not been touched (NO in step S711), the processing proceeds to step S705.

In step S712, the CPU 212 displays notification information on the print setting screen 300 to prompt confirmation about whether to discard the place name management information acquired as a result of the process for updating place name management information in step S702.

In step S713, the CPU 212 determines whether discarding the place name management information acquired in step S702 is selected. In a case where discarding the place name management information is selected (YES in step S713), the processing proceeds to step S714. In a case where discarding the place name management information is not selected (NO in step S713), the processing proceeds to step S705.

In step S714, the CPU 212 discards (deletes, clears) the place name management information acquired in step S702 from the non-volatile memory 215.

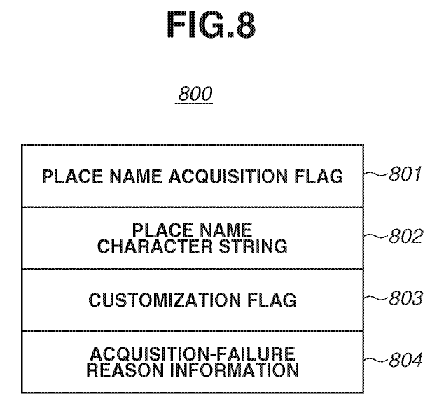

The place name management information managed by the printing application will be described with reference to FIG. 8. FIG. 8 is a diagram illustrating a data structure of place name management information 800 stored in the non-volatile memory 215. The CPU 212 records place name information corresponding to position information associated with the image and acquired using the place name information acquisition API as the place name management information 800 for each image (i.e., in association with the image) in the non-volatile memory 215. The place name management information 800 includes a place name acquisition flag 801, a place name character string 802, a customization flag 803, and acquisition-failure reason information 804. The place name acquisition flag 801 is information indicating whether place name information corresponding to position information associated with the image has been acquired using the place name information acquisition API. The place name character string 802 is a character string to be superimposed on the image in a case where the capture location setting is on. In a case where the place name information acquired using the place name information acquisition API is to be superimposed directly, information indicating a character string, such as “Kawasaki City” or “Seoul Special Metropolitan City”, is recorded. In a case where the user has performed a character string input operation and has edited the place name information to be superimposed, information indicating the edited (customized) character string reflecting the result of the character string input operation performed by the user is recorded. The customization flag 803 is information indicating whether the user has performed a character string input operation and has edited (customized) the place name information to be superimposed. The acquisition-failure reason information 804 is information indicating the reason for failure to acquire place name information in a case where acquisition of the place name information fails. For example, information indicating that the cause of the position information acquisition failure is that the position information is not recorded in the image file (referred to as “reason 1”) is recorded. Further, a case where, for example, the position information is added to the image file will be described. In this case, information indicating that the cause of the acquisition failure is that no corresponding place name is recorded on the place name information management server 104 as a result of a query about place name information corresponding to the position information using the place name information acquisition API (referred to as “reason 2”) is recorded. In a case where position information is to be acquired for a plurality of images (i.e., images selected on the picture selection screen), a plurality of items of the place name management information 800 corresponding to the plurality of images is generated.

FIG. 9 is a flowchart illustrating the process for updating place name management information. The process is a detailed process of step S702 in FIG. 7. The process is realized by the CPU 212 by loading the printing application program recorded in the program memory 213 into the data memory 214 and executing the program.

In step S901, the CPU 212 determines whether the corresponding place name management information 800 is stored for each image to be printed (each image selected on the picture selection screen) in the non-volatile memory 215. In a case where the corresponding place name management information 800 is not stored for each image to be printed (NO in step S901), the processing proceeds to step S902. In a case where the corresponding place name management information 800 is stored for each image to be printed (YES in step S901), the processing proceeds to step S903.

In step S902, the CPU 212 creates (generates) the corresponding place name management information 800 for each image to be printed. In the place name management information 800 created in step S902, “False”, “Null”, “False”, and “Null” are set as initial values in the place name acquisition flag 801, the place name character string 802, the customization flag 803, and the acquisition-failure reason information 804, respectively.

In step S903, the CPU 212 determines whether the image processing apparatus 200 can connect to the Internet. In a case where the CPU 212 determines that the image processing apparatus 200 cannot connect to the Internet (NO in step S903), the processing proceeds to step S904. In a case where the CPU 212 determines that the image processing apparatus 200 can connect to the Internet (YES in step S903), the processing proceeds to step S905.

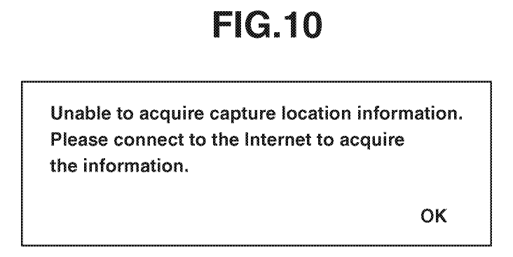

In step S904, the CPU 212 displays notification information on the print setting screen 300 or the capture location setting screen 500 to notify the user that place name information cannot be acquired because the image processing apparatus 200 cannot connect to the Internet, and the process for updating place name management information is terminated. FIG. 10 illustrates an example of the notification information displayed in step S904 to notify the user that place name information cannot be acquired because a connection cannot be established with the Internet. As illustrated, information indicating that acquisition of the capture location (place name, location name) has failed and connecting to the Internet may enable acquisition of the capture location is displayed. Further, the notification information also indicates that the cause of the failure to acquire place name information is the absence of a connection to the Internet.

In step S905, the CPU 212 sets one item of the place name management information 800 as a processing target, among one or more items of the place name management information 800 corresponding to the images to be printed. For example, in a case where there are three images to be printed, the place name management information 800 corresponding to the first image is set as a processing target.

In step S906, the CPU 212 determines whether the place name acquisition flag 801 of the place name management information 800 set as the processing target is True. In a case where the place name acquisition flag 801 is True (YES in step S906), the processing proceeds to step S913 (i.e., the place name acquisition process is skipped). Otherwise (NO in step S906), the processing proceeds to step S907, and the place name acquisition process from step S907 is performed.

In step S907, the CPU 212 acquires position information from attribute information corresponding to the image to be printed.

For example, position information is acquired from Exchangeable Image File Format (Exif) information of the image file. In a case where the image capturing apparatus is set to associate position information with an image when the image is captured, position information acquired using the GPS unit 205 during imaging and indicating a position of the image capturing apparatus is associated with the captured image as attribute information. In step S907, the position information associated as described is acquired if available. In a case where the image capturing apparatus is not set to associate position information with an image when the image is captured or in a case where the GPS unit 205 is not included and a function configured to acquire position information is not included, no position information is associated with the captured image as attribute information. In a case where such an image is to be printed, position information cannot be acquired in step S907.

In step S908, the CPU 212 determines whether position information about the image has been acquired in step S907. In a case where position information has been acquired (YES in step S908), the processing proceeds to step S909. In a case where position information has not been acquired (NO in step S908), the processing proceeds to step S912.

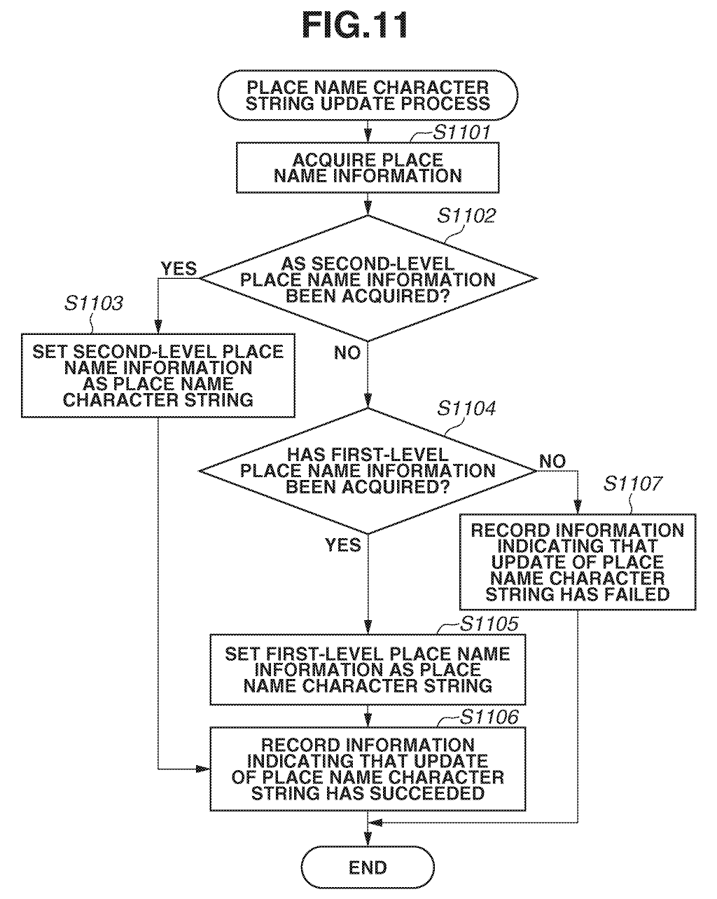

In step S909, the CPU 212 performs a process for updating the place name character string using the place name information acquisition API. The process for updating the place name character string will be described below with reference to FIG. 11.

In step S910, the CPU 212 determines whether the update of the place name character string in step S909 has succeeded. In a case where the CPU 212 determines that the update has succeeded (YES in step S910), the processing proceeds to step S911. Otherwise (in a case where the CPU 212 determines that the update has failed) (NO in step S910), the processing proceeds to step S912.

In step S911, the CPU 212 sets the place name acquisition flag 801 of the place name management information 800 set as the processing target to True (the CPU 212 records True in the place name acquisition flag 801).

In step S912, the CPU 212 sets a character string indicating the reason for the failure to acquire the place name management information in the acquisition-failure reason information 804 of the place name management information 800 loaded into the data memory 214 in step S905. The character string set in the acquisition-failure reason information of the place name management information in step S912 varies depending on the reason for the failure to acquire the place name management information. For example, in a case where it is determined that acquisition of position information about the image has failed in step S908, a character string indicating the failure to acquire position information is set, and in a case where it is determined that the character string indicates a failure in step S910, a character string indicating that the character string indicates a failure is set. Further, in a case where the cause of the failure to acquire position information is that no position information is associated with the image, notification information notifying the user of the cause may be displayed on the print setting screen 300 or the capture location setting screen 500.

In step S913, the CPU 212 determines whether the process from step S905 to step S912 has been performed on all image data to be printed. In a case where the CPU 212 determines that the process from step S905 to step S912 has been performed on all image data to be printed (YES in step S913), the process for updating place name management information is terminated. In a case where the CPU 212 determines that the process from step S905 to step S912 has not been performed on all image data to be printed (NO in step S913), the processing proceeds to step S905, and the process is performed on the next image. For example, in a case where there are three images to be printed and the process for the place name management information 800 corresponding to the first image as a processing target is complete while the process for the second and third images is incomplete, the processing proceeds to step S905. Then, in step S905, the process is repeated for the place name management information 800 corresponding to the second image as a processing target.

FIG. 11 is a flowchart illustrating the process for updating the place name character string. The process is a detailed process of step S909 in FIG. 9. The process is realized by the CPU 212 by loading the printing application program recorded in the program memory 213 into the data memory 214 and executing the program.

In step S1101, the CPU 212 acquires place name information using the place name information acquisition API from the position information acquired in step S907 and stores the acquired place name information in the data memory 214. More specifically, a request to acquire two information items including the first-level place name information and the second-level place name information is issued to the place name information management server 104 via the Internet using position information (such as the position information presented in the column 601) as a query using the place name information acquisition API. While acquisition of two information items including the first-level place name information and the second-level place name information is requested in the present embodiment, acquisition of four information items including the landmark information and the third-level place name information may be requested.

In step S1102, the CPU 212 determines whether the second-level place name information has been acquired from the place name information stored in the data memory 214. In a case where the second-level place name information has been acquired (YES in step S1102), the processing proceeds to step S1103. Otherwise (NO in step S1102), the processing proceeds to step S1104.

In step S1103, the CPU 212 sets the second-level place name information acquired in step S1101 as the place name character string 802 of the place name management information 800.

In step S1104, the CPU 212 determines whether the first-level place name information has been acquired from the place name information stored in the data memory 214. In a case where the first-level place name information has been acquired (YES in step S1104), the processing proceeds to step S1105. Otherwise (NO in step S1104), the processing proceeds to step S1107.

In step S1105, the CPU 212 sets the first-level place name information acquired in step S1101 as the place name character string 802 of the place name management information 800.

In step S1106, the CPU 212 records, in the data memory 214, information indicating that the update of the place name character string has succeeded, and the process for updating the place name character string is terminated. In this case, the result of the determination in step S910 described above is Yes.

In step S1107, the CPU 212 records, in the data memory 214, information indicating that the update of the place name character string has failed, and the process for updating the place name character string is terminated. In this case, the result of the determination in step S910 described above is No.

As described above, in a case where the second-level place name information is acquired in step S1101, the second-level place name information is set as the place name character string 802 in step S1103. Further, in a case where the second-level place name information is not acquired in step S1101 while the first-level place name information is acquired, the first-level place name information is set as the place name character string 802. In other words, the CPU 212 can display a preview image with place name information superimposed on the preview image in step S703 or S1410 without user operation for selecting the second-level place name information or the first-level place name information to be set as the place name character string 802. This makes it possible to superimpose a more appropriate place name while reducing the burden on the user. In other words, a more appropriate place name can be used efficiently from a plurality of place names with different levels.

FIG. 12 is a flowchart illustrating the advanced setting process. The process is a detailed process of step S708 in FIG. 7. The process is realized by the CPU 212 by loading the printing application program recorded in the program memory 213 into the data memory 214 and executing the program.

In step S1201, the CPU 212 displays the advanced setting screen 400 illustrated in FIG. 4.

In step S1203, the CPU 212 determines whether the capture location setting item (the region 407) has been touched. In a case where the region 407 has been touched (YES in step S1203), the processing proceeds to step S1204. Otherwise (NO in step S1203), the processing proceeds to step S1205.

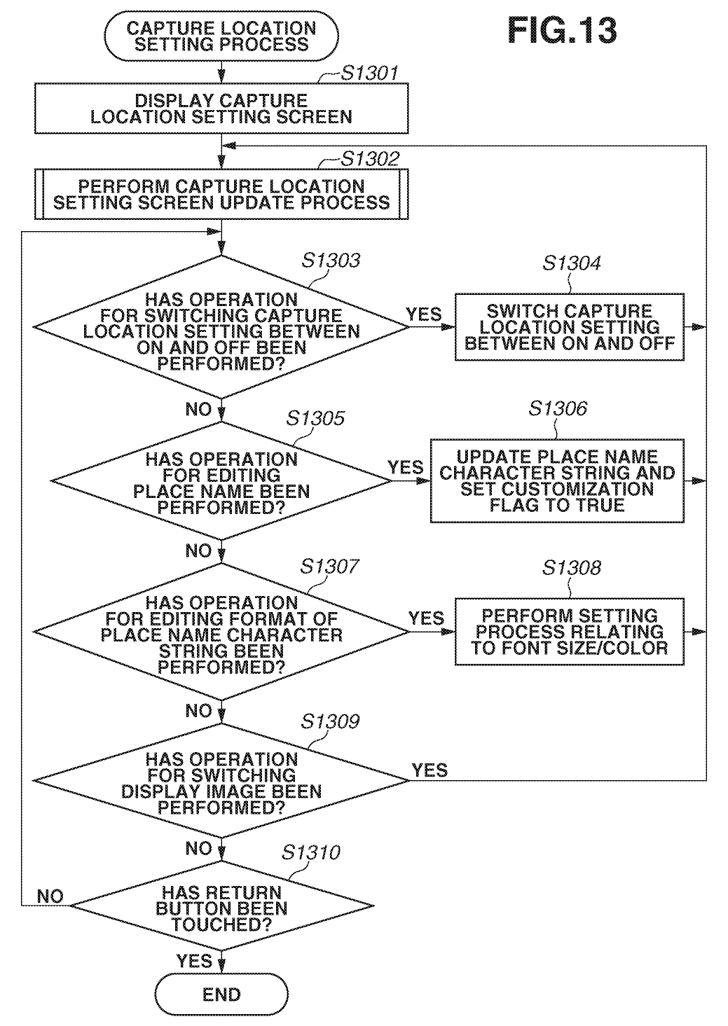

In step S1204, the CPU 212 performs the capture location setting process. The capture location setting process will be described below with reference to FIG. 13.

In step S1205, the CPU 212 determines whether the date setting item (the region 406) has been touched. In a case where the region 406 has been touched (YES in step S1205), the processing proceeds to step S1206. Otherwise (NO in step S1205), the processing proceeds to step S1207.

In step S1206, the CPU 212 performs the date setting process, which is a process for changing the date setting to be printed on the image to be printed. Specifically, in a case where the date setting is on, the date setting is switched to off, and in a case where the date setting is off, the date setting is switched to on. In other words, the date setting is switched between on and off each time the date setting item is touched. The setting is recorded in the non-volatile memory 215.

In step S1207, the CPU 212 determines whether any other setting item region, i.e., any of the regions 402 to 405, has been touched. In a case where any of the regions 402 to 405 has been touched (YES in step S1207), the processing proceeds to step S1208. Otherwise (NO in step S1207), the processing proceeds to step S1209.

In step S1208, the CPU 212 performs a setting process corresponding to the setting item that has been determined to be touched in step S1207. Specifically, in a case where the paper size setting item (the region 402) has been touched, the process for changing the paper size of the image to be printed is performed to change the paper size setting based on a user operation. In a case where the paper type setting item (the region 403) has been touched, the process for changing the paper type of the image to be printed is performed to change the paper type setting based on a user operation. The same applies to the paper feed method setting item and the border setting (borderless printing setting) item, and the paper feed method and the border setting may be changed based on a user operation.

In step S1209, the CPU 212 determines whether the return button (the region 401) has been touched. In a case where the region 401 has been touched (YES in step S1209), the advanced setting process is terminated. Then, the print setting screen is displayed, and the processing proceeds to step S705. In a case where the region 401 has not been touched (NO in step S1209), the processing proceeds to step S1203.

FIG. 13 is a flowchart illustrating the capture location setting process. The process is a detailed process of step S1204 in FIG. 12. The process is realized by the CPU 212 by loading the printing application program recorded in the program memory 213 into the data memory 214 and executing the program.

In step S1301, the CPU 212 displays the capture location setting screen 500 illustrated in FIGS. 5A and 5B.

In step S1302, the CPU 212 performs a process for updating the capture location setting screen. The process for updating the capture location setting screen will be described below with reference to FIG. 14.

In step S1303, the CPU 212 determines whether an operation for switching the capture location setting between on and off (a touched operation on the region 502) has been performed. In a case where an operation for switching the capture location setting between on and off has been performed (YES in step S1303), the processing proceeds to step S1304. Otherwise (NO in step S1303), the processing proceeds to step S1305.

In step S1304, the CPU 212 switches the capture location setting between on and off. More specifically, in a case where the capture location setting is off, the capture location setting is switched to on based on the operation for switching the capture location setting between on and off, and the processing proceeds to step S1302. Further, as a result of switching the capture location setting to on, the regions 503 to 511 are enabled and displayed by the process for updating the capture location setting screen, which will be described below, and in a case where place name information has not yet been acquired for the image being set, the place name information is acquired and superimposed and displayed on the preview image. Further, in a case where the capture location setting is on and an operation for switching the capture location setting between on and off is performed, the capture location setting is switched to off, and the processing proceeds to step S1302. Further, as a result of switching the capture location setting to off, the regions 503 to 511 (other than the regions 501 and 502) are disabled (grayed out) and displayed by the process for updating the capture location setting screen, which will be described below. In a case where the capture location setting is off, the regions 503 to 511 (other than the regions 501 and 502) are disabled and placed in a state where no operation can be received. Accordingly, as long as the capture location setting remains off, the results of the determinations in steps S1305, S1307, and S1309 described below are No, regardless of the actual operation state.

In step S1305, the CPU 212 determines whether an operation for editing the character string displayed in the textbox (the region 507) has been performed. Specifically, the CPU 212 determines whether the region 507 has been touched and a character string input operation has been performed to edit the displayed place name. Touching the region 507 displays a software keyboard, and the character string displayed in the region 507 can be edited based on an operation performed on the software keyboard. In a case where the CPU 212 determines that an operation for editing the character string displayed in the region 507 and indicating the place name has been performed (YES in step S1305), the processing proceeds to step S1306. Otherwise (NO in step S1305), the processing proceeds to step S1307.

In step S1306, the CPU 212 updates the place name character string 802 of the place name management information 800 about the displayed preview image to the character string updated by the user in step S1305. Further, the customization flag 803 is set to True. Then, the processing proceeds to step S1302, and the preview image to which the place name character string 802 changed to the place name 504 has been applied is displayed in the region 503.

In step S1307, the CPU 212 determines whether an operation for editing a format of the place name character string to be superimposed on the image has been performed. Specifically, the CPU 212 determines whether an operation has been performed on any of the regions 509 to 511. In a case where an operation has been performed on any of the regions 509 to 511 (YES in step S1307), the processing proceeds to step S1308. Otherwise (NO in step S1307), the processing proceeds to step S1309.

In step S1308, the CPU 212 performs a setting process to change the font size, color, or border of the place name to be superimposed on the image based on the operation performed on any of the regions 509 to 511. Then, the processing proceeds to step S1302, and the changed format is applied.

In step S1309, the CPU 212 determines whether the display image switch button (the region 506) has been touched. In a case where the CPU 212 determines that the region 506 has been touched (YES in step S1309), step S1302 is performed after the image to be displayed is switched, among the plurality of images selected as images to be printed (images to be superimposed), and the capture location setting screen is displayed with the switched image. In a case where the region 506 has not been touched (NO in step S1309), the processing proceeds to step S1310.

In step S1310, the CPU 212 determines whether the return button (the region 501) has been touched. In a case where the CPU 212 determines that the region 501 has been touched (YES in step S1310), the capture location setting process is terminated. Then, the advanced setting screen is displayed, and the processing proceeds to step S1203. In a case where the region 501 has not been touched (NO in step S1310), the processing proceeds to step S1303.

FIG. 14 is a flowchart illustrating the process for updating the capture location setting screen. The process is a detailed process of step S1302 in FIG. 13. The process is realized by the CPU 212 by loading the printing application program recorded in the program memory 213 into the data memory 214 and executing the program.

In step S1401, the CPU 212 references the setting information stored in the non-volatile memory 215 and determines whether the capture location print setting is on. In a case where the CPU 212 determines that the capture location print setting is on (YES in step S1401), the processing proceeds to step S1402. Otherwise (in a case where the capture location print setting is off) (NO in step S1401), the processing proceeds to step S1412.

In step S1402, the CPU 212 performs the process for updating place name management information. The process for updating place name management information is described above with reference to FIG. 9.

In step S1403, the CPU 212 loads (acquires) the place name management information 800 corresponding to the image displayed in the region 503 into the data memory 214.

In step S1404, the CPU 212 determines whether at least one (one or both) of the place name acquisition flag 801 and the customization flag 803 of the place name management information 800 is True. In a case where at least one (one or both) of the place name acquisition flag 801 and the customization flag 803 is True (YES in step S1404), the processing proceeds to step S1405. In a case where the place name acquisition flag 801 and the customization flag 803 are both False (NO in step S1404), the processing proceeds to step S1406.

In step S1405, the CPU 212 displays, in the region 507, the character string set as the place name character string 802 of the place name management information 800. For example, “Ota City” is displayed in the region 507 as illustrated in FIG. 5A.

In step S1406, the CPU 212 displays the character string “(Unknown)” in the region 507. For example, as illustrated in FIG. 5B, “(Unknown)” is displayed in the region 508. As described above, the character string “(Unknown)” is not superimposed on the preview image displayed in the region 503. In the present embodiment, in a case where acquisition of place name information fails, the character string “(Unknown)” is displayed in the region 507, while the character string “(Unknown)” is not superimposed on the image data to be printed, as described above, thereby indicating to the user that the place name superimposition function of the printing application operates normally without any malfunction, and the user can correctly recognize that acquisition of place name information has failed. Furthermore, degradation of image quality caused by the superimposition of the character string “(Unknown)” on the image to be printed can be suppressed. In other words, erroneous recognition by the user and degradation of image quality can be suppressed in a case where name information about a place indicated by position information cannot be acquired. The character string “(Unknown)” may be changed to a different character string indicating the failure to acquire place name information, such as “(Unable to Acquire Place Name Information)”, “No Place Name Information”, “(Null)”, or “(XXXX)”.

In step S1407, the CPU 212 references the setting information stored in the non-volatile memory 215 and determines whether the date setting is on. In a case where the CPU 212 determines that the date setting is not on (the date setting is off) (NO in step S1407), the processing proceeds to step S1408. In a case where the CPU 212 determines that the date setting is on (YES in step S1407), the processing proceeds to step S1409.

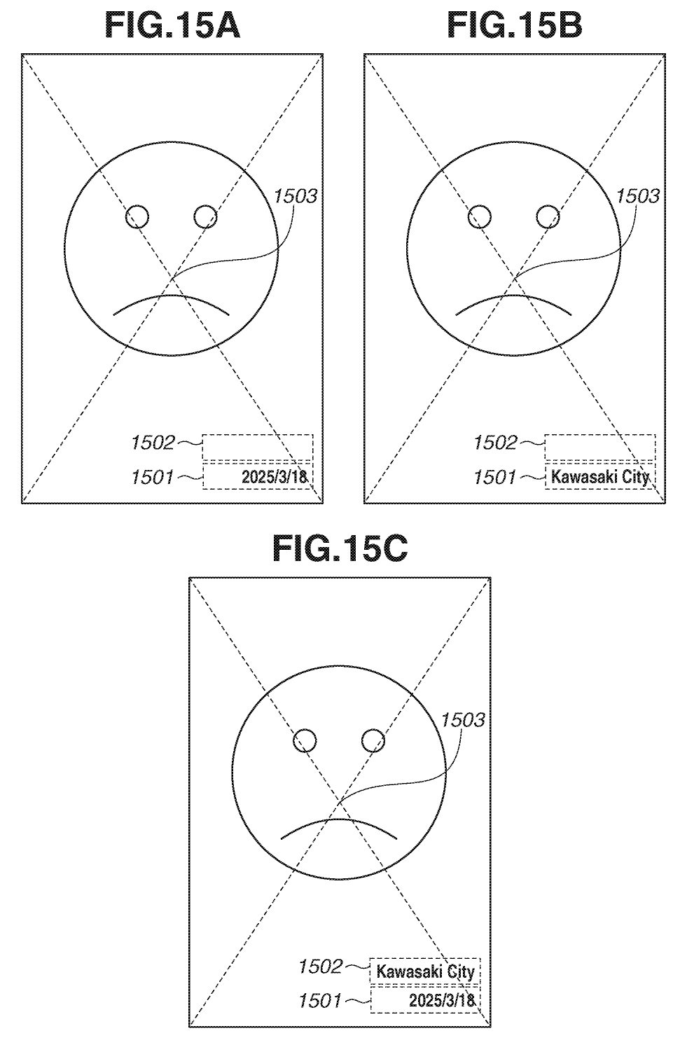

In step S1408, the CPU 212 determines to superimpose the character string set as the place name character string 802 (i.e., the same character string as the character string displayed in the region 507) on a first region of the image to be printed. FIG. 15B illustrates an example of an image with the place name character string 802 superimposed on the image based on the determination. Details thereof will be described below.

In step S1409, the CPU 212 determines to superimpose the character string indicating the date information on the first region of the image to be printed. Further, the CPU 212 determines to superimpose the character string set as the place name character string 802 (i.e., the same character string as the character string displayed in the region 507) on not the first region but a second region of the image to be printed. FIG. 15C illustrates an example of an image on which both a date character string indicating the date information (additional information of a first type) and the place name character string 802 (additional information of a second type) are perceptibly superimposed based on the determinations. Details thereof will be described below.

In step S1410, the CPU 212 generates image data (SVG data) with the place name character string and/or the date character string superimposed on the position (region) determined in step S1408 or S1409, and displays a preview image generated by reducing the generated SVG data in the region 503. In other words, an image on which the place name information is superimposed is generated by the process and perceptibly presented. The place name character string and the date character string superimposed (added) on the image are perceptible to the user. The process for generating an image on which the place name information is superimposed in step S1410 is performed without user operation for inputting or selecting a place name before an operation for editing (customizing) the place name is performed in steps S1305 and S1306 in a case where place name information can be acquired. Further, the process for generating an image on which the place name information is superimposed in step S1410 is performed without user operation for adjusting the placement of the place name character string and the date character string.

In step S1411, the CPU 212 enables the regions 503 to 511 of the capture location setting screen 500 and places the regions 503 to 511 in a state where a user operation can be received.

In step S1412, the CPU 212 disables and grays out the regions 503 to 511 of the capture location setting screen 500 and places the regions 503 to 511 in a state where no user operation can be received.

FIGS. 15A-15C illustrate examples of images of SVG data generated in step S703 in FIG. 7 or in step S1410.

FIG. 15A illustrates an example of SVG data generated in a case where the date setting is on and the capture location setting is off. The date character string is superimposed on the first region (a region 1501 in FIG. 15A) of the image. The first region is positioned along a peripheral portion of the image so that the first region does not overlap a center 1503 of the image to prevent a reduction in visibility of a main subject, which typically appears near the center 1503 of the image. In the present embodiment, the first region is positioned at a lower right portion of the image.

FIG. 15B illustrates an example of SVG data generated in a case where the date setting is off and the capture location setting is on. The place name character string is superimposed on the first region (the region 1501 in FIG. 15B). The first region corresponds to the region at the position on which the date character string is superimposed in FIG. 15A. Like the date character string, the place name character string is superimposed on the first region along the peripheral portion of the image to prevent a reduction in visibility of the main subject, which typically appears near the center 1503 of the image.

FIG. 15C illustrates an example of SVG data generated in a case where the date setting is on and the capture location setting is on. The date character string is superimposed on the first region (the region 1501 in FIG. 15C), and the place name character string is superimposed on the second region (a region 1502 in FIG. 15C). The first region (the region 1501 in FIG. 15C) is farther from the center 1503 of the image than the second region (the region 1502 in FIG. 15C) is. Further, the first region (the region 1501 in FIG. 15C) and the second region (the region 1502 in FIG. 15C) do not overlap with each other. The second region is also positioned near the peripheral portion of the image so that the second region does not overlap the center 1503 of the image to prevent a reduction in visibility of the main subject, which typically appears near the center 1503 of the image. Further, the second region is closer to the center 1503 of the image than the first region is. In the present embodiment, the second region is positioned above the first region. As described above, in a case where both the place name and the date are superimposed on the image to be printed, the date information is superimposed on a position farther from the center of the image while reducing the possibility of hiding an important subject.

As apparent from a comparison of FIGS. 15A and 15C, the position on which the date character string is superimposed is in the first region in both a case where the capture location setting is off (FIG. 15A) and a case where the capture location setting is on (FIG. 15C). In other words, the display position of the date character string is set to be in the same first region regardless of whether the place name is superimposed. This is because the function configured to superimpose date information on an image is more frequently used by the user than the function configured to superimpose a place name on an image. The factor responsible for the difference in frequency of use is that the image capturing apparatus can associate capture date and time information set as the date character string with an image even in a case where the image capturing apparatus does not include the GPS function, i.e., the number of images to which the date information superimposition function is applied is greater than the number of images to which the place name superimposition function is applied. Another factor is that the image capturing apparatuses and the image processing apparatuses that include the date information superimposition function are more widely adopted in the market than the image capturing apparatuses and the image processing apparatuses that include the place name superimposition function. If the position on which the date character string is superimposed varies depending on whether the place name character string is superimposed, the user may feel strange or perceive a lack of uniformity. Thus, the position on which the date character string is superimposed is set to be in the first region regardless of whether the place name character string is superimposed, thereby preventing the user from perceiving visual inconsistency or a lack of uniformity.

As apparent from a comparison of FIGS. 15B and 15C, the position on which the place name character string is superimposed differs between a case where the date character string is superimposed (FIG. 15C) and a case where the date character string is not superimposed (FIG. 15B). The place name character string is superimposed as far from the center 1503 of the image as possible while avoiding the position where the date character string is displayed, thereby prioritizing the prevention of a reduction in visibility of a main subject. Further, in a case where both the date character string and the place name character string are superimposed, the date character string and the place name character string are both superimposed on the lower right portion, instead of separating the date character string and the place name character string in upper and lower portions. This suppresses the superimposition of the character strings at various positions on the image, thereby enhancing the quality of the image on which the place name character string and the date character string are both superimposed.

The control of the superimposition positions of names to be superimposed, such as the place name and the date, which is illustrated in FIGS. 15A-15C, is performed depending on the setting without user operation for specifying the superimposition position. Further, neither of the regions 1501 and 1502 includes the center 1503 of the image.

While an example in which the CPU 212 acquires the position information from the attribute information about the image to be printed in step S907 in FIG. 9 is described above, this is not intended to be limiting, and position information about a location at which the image processing apparatus 200 exists at the current point may be acquired from the GPS unit 205.

Further, while an example in which the preview image (the image on which the place name is to be superimposed) displayed in the region 302 or 503 is selected from a picture stored in the terminal or the web service is described above, an image captured by the camera 203 may be used. In this case, position information acquired from the GPS unit 205 and indicating a location of the image processing apparatus 200 at a current point may be used, instead of the position information from the attribute information about the image.

While an example in which the CPU 212 determines whether the second-level place name information has been acquired from the place name information stored in the data memory 214 in step S1102 in FIG. 11 is described above, the process may be performed on the landmark information. Specifically, the CPU 212 may determine whether the landmark information has been acquired from the place name information stored in the data memory 214, and in a case where the landmark information has been acquired, the landmark information is set as the place name character string 802 of the place name management information 800.

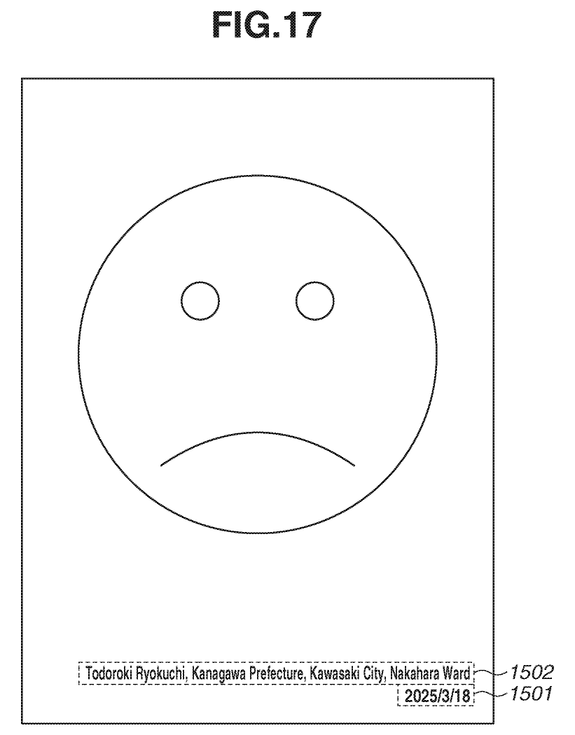

Further, while an example in which one of the first-level place name information and the second-level place name information is set as the place name character string to be superimposed in the process for updating the place name character string in FIG. 11 is described above, both the first-level place name information and the second-level place name information may be superimposed (output) depending on the situation. For example, in a case where the size of paper (print medium) to be output is larger than a predetermined size, such as A3 size or larger, a space for superimposing the place name information is large. Thus, in a case where the size of the medium to be output is larger than the predetermined size and both the first-level place name information and the second-level place name information are acquired, the place name character string corresponding to the first-level place name information and the place name character string corresponding to the second-level place name information may be arranged and superimposed. In a case where the landmark information and the third-level place name information are also acquired, the landmark information and the third-level place name information may also be superimposed. FIG. 17 illustrates an example of an image with all acquired items of place name information arranged and superimposed on the image in a case where the size of the print medium is A3 and the landmark information, the first-level place name information, the second-level place name information, and the third-level place name information are acquired. The character string “Todoroki Ryokuchi” on the region 1502 is a name of a landmark acquired as the landmark information. The character strings “Kanagawa Prefecture”, “Kawasaki City”, and “Nakahara Ward” superimposed on the region 1502 are names acquired as the first-level place name information, the second-level place name information, and the third-level place name information, respectively.

While an example in which touching the region 507 enables the displayed character string to be edited in step S1305 in FIG. 13 is described above, the position information acquired in step S1101 may be stored, and a process for selecting position information from the stored position information may be performed. Specifically, the place name information is displayed in the region 507 without user operation for selecting a place name. Then, the acquired place name information of other levels (such as the first-level place name information and the third-level place name information) and the landmark information may be controlled to be displayed as selectable candidates upon touching the region 507. The place name information selected from the candidates is displayed as an edited place name character string in the region 507 and set as the place name character string 802. This reduces the need to perform a character input operation on the software keyboard in a case where the acquired place name information of another level or the landmark information is to be used during the editing of the place name character string, thereby reducing the burden on the user.

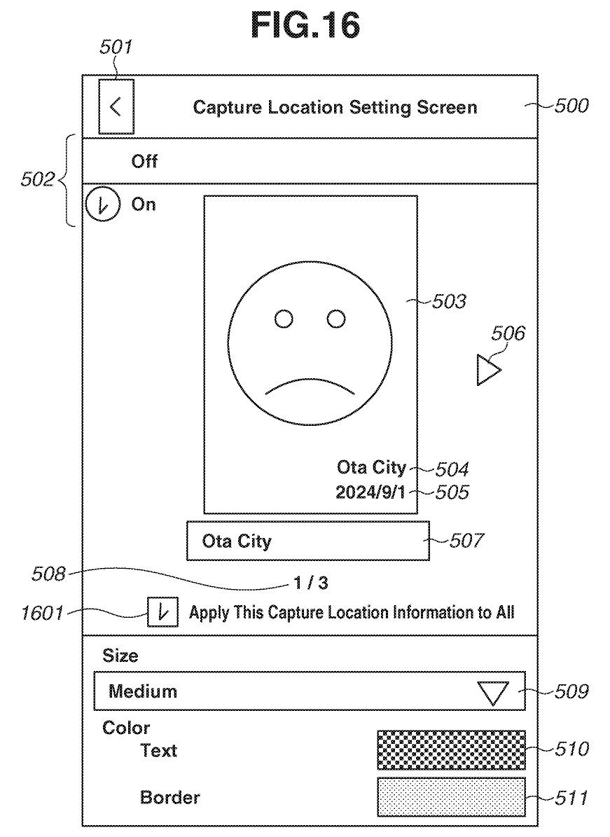

The place name character string (the place name character string set by the process for updating the place name character string in FIG. 11 or the place name character string customized in step S1306) set for a single image may be applied to the other images of the plurality of images selected as images to be printed (images to be superimposed). For example, as illustrated in FIG. 16, the capture location setting screen 500 displays a checkbox 1601 configured to receive an instruction operation for applying the set place name character string to other images. Then, in a case where the checkbox 1601 is selected, the CPU 212 applies, in batch, the place name character string set for the displayed first image to all the place name character strings 802 of the other images of the plurality of images selected as images to be superimposed. In other words, the character strings displayed in the regions 504 and 507 for the first image are applied to the place name character strings 802 of the other images including the second image in batch. This enables application of a place name character string set for an image for which the place name information is acquired to another image for which no place name information is acquired by a simple operation, thereby reducing a user operation for customizing the place name character string. Furthermore, a place name character string customized and edited for a single image can be applied to another image by a simple operation, thereby reducing a user operation for customizing the place name character string.

The various types of control described above as being performed by the CPU 212 may be performed by a single piece of hardware, or a plurality of pieces of hardware (such as a plurality of processors or circuits) may control the entire apparatus by sharing the processing.

Further, while various embodiments of the present disclosure have been described in detail, the present disclosure is not limited to the specific embodiments and encompasses variations that do not depart from the essential features of the disclosure. Furthermore, each embodiment described above merely illustrates an embodiment of the present disclosure, and each embodiment may be combined with another embodiment as needed.

Further, the application to the printing application in the image processing apparatus 200 is described as an example in the above-described embodiment. However, this example is not intended to be limiting, and the above-described embodiment is also applicable to any electronic device configured to output a name associated with a place indicated by position information or any electronic device configured to superimpose a plurality of types of additional information perceptibly on an image. For example, the above-described embodiment is also applicable to an electronic device or application software configured to post an image with a name associated with a place indicated by position information on a social networking service (SNS). The above-described embodiment is also applicable to a case where a plurality of types of additional information, such as a date and a place name, is superimposed on an image to be posted on the SNS.

Further, the above-described embodiment is not limited to a case where a place name associated with an image is output. For example, the above-described embodiment is also applicable to a case where a distribution route of an article is recorded for traceability purposes. Specifically, an information processing apparatus including a GPS unit reads a barcode or equivalent indicating an identification code of the article at a distribution center. Then, the GPS unit acquires position information about the information processing apparatus at the time of reading, and the information processing apparatus requests place name information corresponding to the position information acquired from the GPS unit from the place name information management server 104. Then, the place name information acquired in response to the request and the read identification code of the article are displayed (output) in association or transmitted (output) from the information processing apparatus to a traceability management database. At this time, in a case where the second-level place name information is acquired, the second-level place name information is displayed or transmitted without displaying or transmitting the first-level place name information. Further, in a case where the second-level place name information is not acquired, the first-level place name information is displayed or transmitted.

Further, the above-described embodiment is also applicable to a case where a map application, a car navigation, or the like of an information processing apparatus displays a place name of a current location or a previous location based on the position information acquired from the GPS unit of the information processing apparatus. In other words, in a case where the second-level place name information is acquired, the second-level place name information is displayed without displaying the first-level place name information. Further, in a case where the second-level place name information is not acquired, the first-level place name information is displayed.

The present disclosure enables, with good operability, a more suitable place name to be used from among a plurality of place names with different hierarchical levels.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2025-078028, which was filed on May 8, 2025 and which is hereby incorporated by reference herein in its entirety.

What is claimed is:

1. An information processing apparatus comprising:
at least one memory; and
at least one processor, wherein the at least one processor and the at least one memory are configured to:
acquire position information;
issue a request to acquire, for the position information, a first-level place name and a second-level place name at a lower level than the first level; and
perform control such that in a case where the second-level place name is acquired in response to the request, the second-level place name is output without outputting the first-level place name and without requiring user operation for selecting a place name after the request, and such that in a case where the second-level place name is not acquired while the first-level place name is acquired in response to the request, the first-level place name is output.

2. The information processing apparatus according to claim 1, wherein the position information is output from a positioning sensor.

3. The information processing apparatus according to claim 1, wherein the position information is associated as attribute information about an image.

4. The information processing apparatus according to claim 3, wherein the at least one processor and the at least one memory are further configured to, in a case where the request is not issued due to lack of the position information associated with the image, provide a notification regarding failure to issue the request.

5. The information processing apparatus according to claim 1, wherein the at least one processor and the at least one memory are further configured to perform control such that the first-level place name or the second-level place name that is a place name to be output is output as information for an image.

6. The information processing apparatus according to claim 5, wherein the at least one processor and the at least one memory are further configured to perform control such that the first-level place name or the second-level place name that is a place name to be output is superimposed on the image and output.

7. The information processing apparatus according to claim 1, wherein the at least one processor and the at least one memory are further configured to perform control such that the first-level place name or the second-level place name that is a place name to be output is output as information indicating a distribution route of an article.

8. The information processing apparatus according to claim 1, wherein the at least one memory and the at least one processor are further configured to edit, based on user operation, the first-level place name or the second-level place name that is an output place name.

9. The information processing apparatus according to claim 8, wherein the at least one processor and the at least one memory are further configured to perform control such that in a case where the second-level place name is acquired in response to the request, the second-level place name is output without outputting the first-level place name and without requiring user operation for selecting a place name after the request, and thereafter perform control such that during editing of the output second-level place name, the first-level place name acquired in response to the request is displayed in a selectable state.

10. The information processing apparatus according to claim 8,
wherein the request further includes a request to acquire information about a landmark related to the position information, and
wherein the at least one processor and the at least one memory are further configured to perform control such that during editing of the first-level place name or the second-level place name that is the output place name, a name of the landmark acquired in response to the request is displayed in a selectable state.

11. The information processing apparatus according to claim 8, wherein the at least one processor and the at least one memory are further configured to perform control such that the first-level place name or the second-level place name that is a place name to be output is output as information for the first image, and in a case where the place name output for the first image is edited, the edited content is applied to a second image based on the edited content.

12. The information processing apparatus according to claim 1, wherein the at least one memory and the at least one processor are further configured to output, to a printing apparatus, a superimposed image in which the first-level place name or the second-level place name is superimposed and an instruction to print the superimposed image, as a function of specific application software.

13. The information processing apparatus according to claim 11, wherein the at least one processor and the at least one memory are further configured to perform control such that in a case where a print medium has a size larger than a predetermined size and the first-level place name and the second-level place name are acquired in response to the request, a superimposed image in which the first-level place name and the second-level place name are superimposed is output without user operation for selecting a place name after the request.

14. The information processing apparatus according to claim 1, wherein the at least one memory and the at least one processor are further configured to output a superimposed image in which the first-level place name or the second-level place name is superimposed so that the superimposed image is posted on a social networking service, as a function of specific application software.

15. The information processing apparatus according to claim 1, wherein the at least one processor and the at least one memory are further configured to transmit the request to a system configured to manage the place name corresponding to the position information via the Internet.

16. The information processing apparatus according to claim 15, wherein the at least one processor and the at least one memory are further configured to perform control such that in a case where the request fails to issue due to lack of a connection to the Internet, a notification regarding the lack of the connection to the Internet is provided.

17. The information processing apparatus according to claim 1, wherein the at least one processor and the at least one memory are further configured to perform control such that in a case where at least one of the first-level place name and the second-level place name is acquired in response to the request, a name to be superimposed based on the acquired place name is displayed in a first area not to be superimposed on an image while the name to be superimposed is displayed in a second area to be superimposed on the image, and in a case where neither the first-level place name nor the second-level place name is acquired in response to the request, notification information that is not to be superimposed on the image is displayed in an area not to be superimposed on the image while a name for a place name is not displayed in the second area.

18. The information processing apparatus according to claim 1, wherein the at least one memory and the at least one processor are further configured to:
determine whether additional information of a first type different from a place name is to be superimposed on an image,
perform a first control such that in a case where the additional information of the first type is determined to be superimposed, the additional information of the first type is superimposed on a first region to be superimposed on the image, and additional information of a second type is superimposed on a second region to be superimposed on the image and being farther from a periphery of the image than the first region is, the additional information of the second type being one of the first-level place name and the second-level place name, and
perform a second control such that in a case where the additional information of the first type is not to be superimposed, the additional information of the second type is superimposed on the first region of the image, and the additional information is not superimposed on the second region.

19. A method for controlling an information processing apparatus, the method comprising:
acquiring position information;
issuing a request to acquire, for the acquired position information, a first-level place name and a second-level place name at a lower level than the first level; and
performing control such that in a case where the second-level place name is acquired in response to the request, the second-level place name is output without outputting the first-level place name and without requiring user operation for selecting a place name after the request, and such that in a case where the second-level place name is not acquired while the first-level place name is acquired in response to the request, the first-level place name is output.

20. A non-transitory computer-readable storage medium storing computer-executable instructions that, when executed by one or more computers, cause the one or more computers to:
acquire position information;
issue a request to acquire, for the position information, a first-level place name and a second-level place name at a lower level than the first level; and
perform control such that in a case where the second-level place name is acquired in response to the request, the second-level place name is output without outputting the first-level place name and without requiring user operation for selecting a place name after the request, and such that in a case where the second-level place name is not acquired while the first-level place name is acquired in response to the request, the first-level place name is output.
